(19) United States
(12) Patent Application Publication
(10) Pub. No.: US 2003/0208603 A1
(43) Pub. Date: Nov. 6, 2003

(54) System and method for initiating communication

(76) Inventors: Eyal Manor, Yahud (IL); Zeev Pritzker, Tel Aviv (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/136,450

(22) Filed: May 2, 2002

(51) Int. Cl. G06F 15/16

(52) U.S. Cl. 709/227

(57) ABSTRACT

There is presented a system and method for initiating communication between a computing device with a client application accessing data from a server and a representative workstation associated with the server. According to the present invention, an activity detector may monitor inputs to the computing device and a behavior filter may determine whether the detected activity qualifies for the establishment of communication between the computing device and the representative workstation. A communication module may initiate a communications application, mode or link between the computing device and the representative workstation upon receiving a signal or indicator from the behavior filter.

### FIELD OF THE INVENTION

The present invention relates generally to the field of digital communications. More specifically, the present invention relates to a system and method for initiating communication between a client application and a representative.

### BACKGROUND OF THE INVENTION

The development of the Internet and other similar distributed data communication networks has facilitated an explosive growth in the number of people using client applications such as a web browser to access data on remote servers anywhere in the world. Hoping to tap into a huge potential market of Internet users, many commercial entities have launched web sites (e.g. e-commerce sites, online storefronts, financial institutions) offering to provide any one of a number of different services and/or products. For those potential customers who may not be willing to consummate a transaction without any live interaction with a representative of the commercial entity offering its goods and/or services, certain web sites may provide options for contacting a live representative either by phone or through the Internet.

FIG. 1 shows a computing device with a client application 100, which in this case is a desktop computer with a web browser, receiving data from a server 200 (e.g. web server) over the Internet. Also shown in FIG. 1 is the computer with the client application 100 connected through the Internet to a representative with a workstation 300.

The representative may sit in a call or contact center, and may field numerous inquiries per hour. In some situations, a call or contact center may be distributed, whereby the representatives may sit at home and receive calls with inquiries which may be rerouted through a central location or number. Regardless of the exact configuration of the call or contact center, customer representatives are usually a costly resource and the number of representatives is finite. Providing an option for each person entering a web site to make contact with a representative may create various problems. For example, on a web site with many visitors (e.g. thousands of hits per hour, Amazon.com for example), allowing each visitor to contact a web site representative may result in contact overload at the call or contact center servicing the wed site. Live contact overload may occur when the number of people attempting to engage a representative exceeds the number of available representatives.

### SUMMARY OF THE INVENTION

As part of the present invention, while a computer with a client application 100 (e.g. web browser) is accessing data from a server 200, an activity detector may monitor a user's or visitor's inputs to the computer. The activity monitor may pass the detected activity information to an activity filter which may compare the detected activity against at least one activity parameter. If the detected activity correlates to an activity parameter, a communication module or communication application launcher may be triggered to initiate a mode of communication between the user's computer and a representative associated with the server 200. According to an embodiment of the present invention, the activity parameters may be set and/or adjusted based on a known characteristic of the visitor. According to another embodiment of the present invention, the activity parameters may be set and/or adjusted based on conditions associated with the representative's call or contact center.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing a client application accessing information from a server and communicating with a representative of the server through a distributed data network;

FIG. 2 is a block diagram of a communication system according to the present invention;

FIG. 3 is a block diagram showing an example of an activity filter according to the present invention;

FIG. 4 is a flow diagram showing the steps of a method by which communication may be initiated according to the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

As part of the present invention, while a computer with a client application 100 (e.g. web browser) is accessing data from a server 200, an activity detector may monitor a user's or visitor's inputs to the computer. The activity monitor may pass the detected activity information to an activity filter which may compare the detected activity against at least one activity parameter. If the detected activity correlates to an activity parameter, a communication module or communication application launcher may be triggered to initiate a mode of communication between the user's computer and a representative associated with the server 200. According to an embodiment of the present invention, the activity parameters may be set and/or adjusted based on a known characteristic of the visitor. According to another embodiment of the present invention, the activity parameters may be set and/or adjusted based conditions associated with the representative's call or contact center.

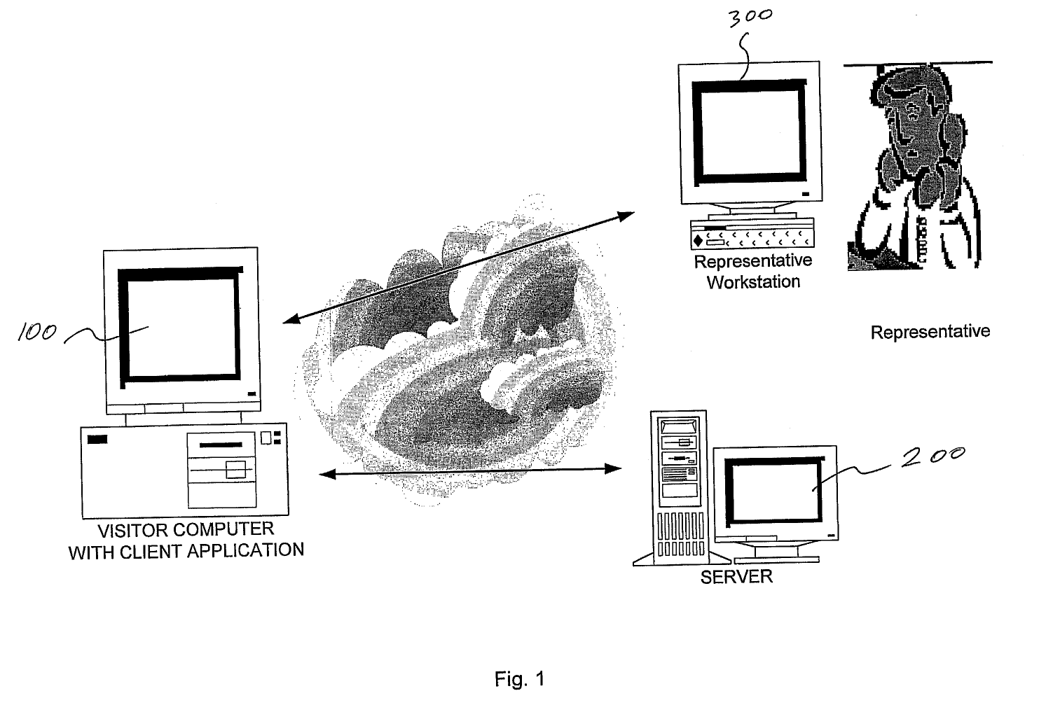

Turning now to FIG. 1, there is shown a computer with a client application 100 communicating via the Internet, or other equivalent distributed data network, with a server 200. The server 200 may contain data associated with a commercial enterprise, educational service, government body, news service, or any other entity having activity on the Internet. The computer or computing device with the client application 100 may access data on the server 200 using either TCP/IP, UDP, or any other protocol known in the art. Both the client application 100 and the server 200 are associated with unique I.P. addresses and packets containing requests for data and responses to the requests are addressed and sent over the Internet using these I.P. addresses. Accessing data or content and transferring the data over the Internet is well known. Therefore, a discussion on this subject is not needed.

Also shown in FIG. 1 is a representative workstation 300 associated with the server 200. The representative workstation may reside in proximity to the server 200 or may be placed anywhere in the world. The workstation may consist of a computer and/or a telephone, or any other combination of communication enabled devices. Stored on the server 200 may be data (e.g. a link with the URL or I.P. address) directing the computer with the client application 100 to the representative workstation 300. For example, if the server 200 is providing content and transaction processing associated with an online storefront, somewhere within the server 200 may be a link to a workstation 300 associated with the online storefront. The workstation 300 may be manned by a customer service representative whose job is to assist people in consummating a transaction on the online storefront.

The link stored on the server 200 may cause the client application to request one of several modes of communication with the representative workstation 300. Among the modes of communication available today are Voice Over Internet Protocol (“VOIP”), Video Over Internet Protocol (“VOIP”), Chat, Co-browsing, Application Sharing, and a telephone Call Back from the representative. Each of the above listed modes may be facilitated by the client application 200 or by another application or plug-in which may be downloaded to the computer with the client application 100. Individually facilitating each of the above list modes of communications is known in the art. There are numerous software application and protocols which may facilitate one of the above listed modes of communication between the computer with the client application 100 and the workstation 300. The present invention is applicable to all of the above listed modes of communication and any other modes presently known or to be devised in the future.

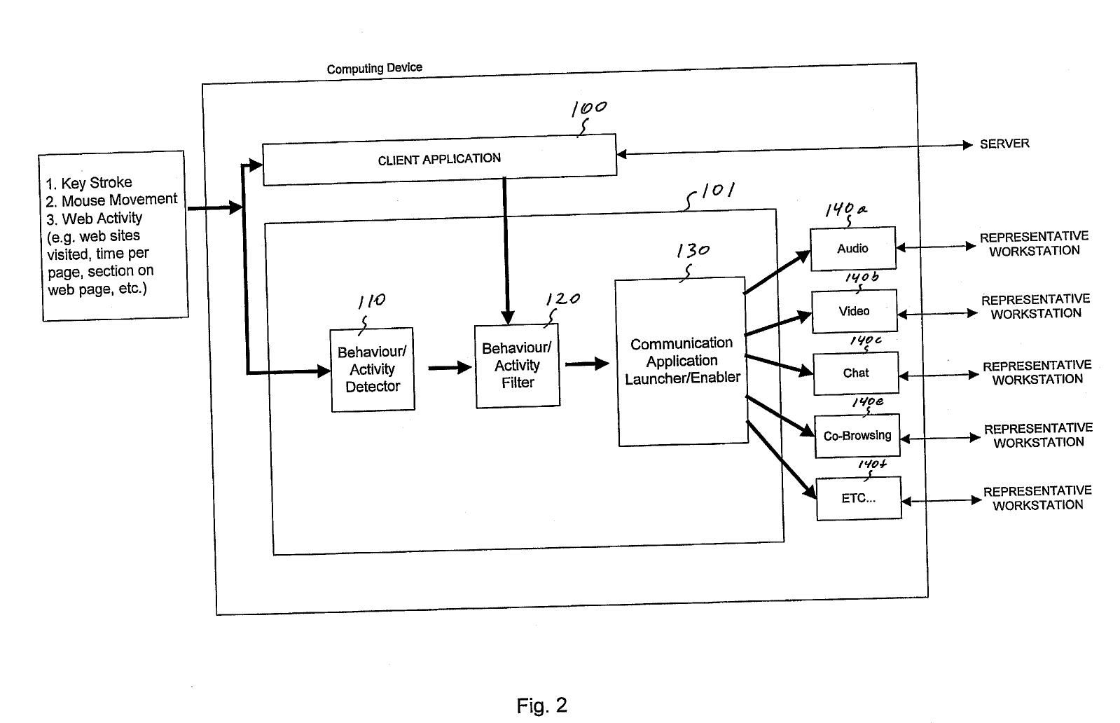

Turning now to FIG. 2, there is shown a block diagram of a system for initiating a mode of communication 101 according to the present invention. The system may reside on the same computer or computing device as the client application 100. A behavior monitor 110 or activity detector 110 may receive or intercept signals from an input device associated to the computer or computing device. For example, the behavior monitor may track a user's key strokes, mouse/cursor movements, content accessed by the client application 100 (e.g. web pages), duration of time spent viewing specific content (e.g. web page or a specific section of a specific web page), etc.. The behavior monitor 110 may pass the activity information to a behavior or activity filter 120.

The activity filter 120 may compare the received activity information against one or more activity parameters. If the detected activity sufficiently correlates to an activity parameter, the activity filter may signal a communication application launcher or enabler 130. Upon receiving a signal from the behavior filter 120, the communication application launcher or enabler 130 may either launch or enable a communication application 140a-140e, which may facilitate communications between the computer with the client application 100 and the representative workstation 130.

For example, the behavior filter 120 may compare the amount of time a client application 100 is accessing or displaying a specific section of a specific web page (e.g. a page showing a new watch). Once the activity, which in this example is the viewing of specific content, correlates to a specific behavior or activity parameter, in this example a predefined period of time accessing the same content, the activity filter 120 may issue a command to the application launcher/enabler 130 to either launch or enable a communication application associated with the specific activity parameter.

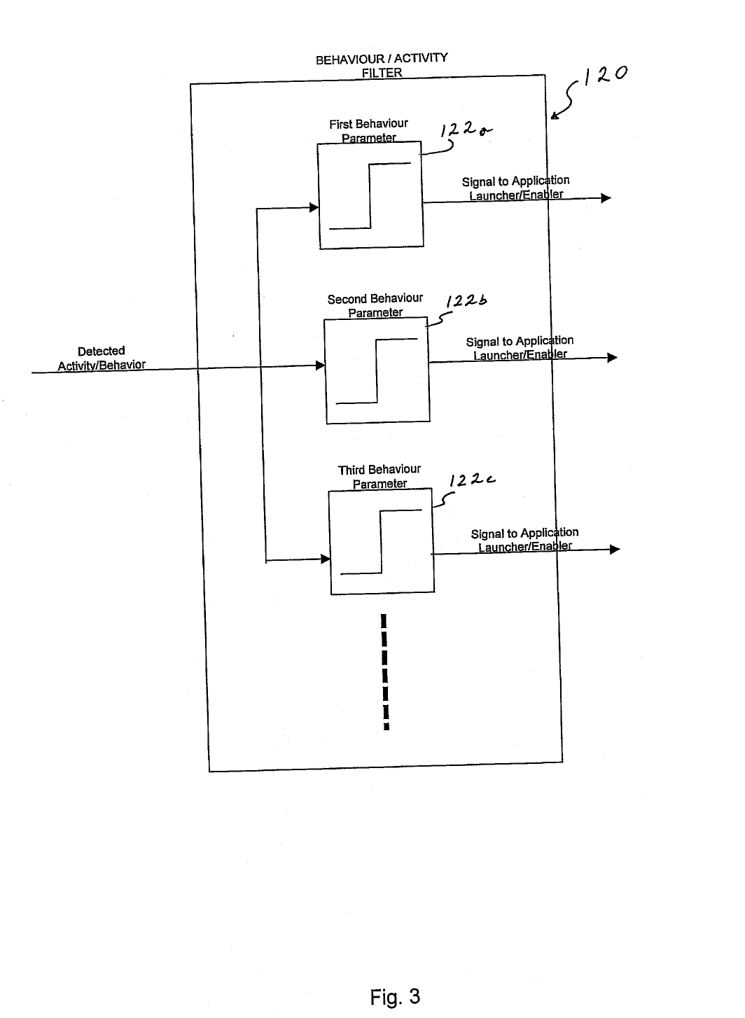

Turning now to FIG. 3, there is shown an example of a behavior or activity filter 120 according to the present invention. Each activity parameter, 122a to 122c, in the behavior filter 120 may be associated with a specific communications application or a specific set of communication applications. For example, activity parameter 122a may relate to a form filling activity on a specific web form on the server 200. The parameter 122a may have a predefined or dynamic threshold value for the number or type of characters entered into the form. Once the number of characters entered into the form reaches the threshold value, the activity filter 120 may produce a signal indicating that the detected activity correlates with the activity parameter 122a. The communication application launcher/enabler 130 may direct a communication application associated with the first behavior/activity parameter 122a (e.g. a chat application 140c) to request a connection with a corresponding application on the representative workstation 300.

In another Example, the second behavior/activity parameter 122b may relate to the amount of time spent accessing specific content, and the third behavior/activity parameter 122c may relate to the number of times the client application 100 accessed the same content over some period of time. An activity parameter may relate to any combination of user driven and external events (e.g. keystrokes, mouse movement, content accessed, time spent accessing content, etc . . . ). Once a detected activity sufficiently correlates to a specific activity parameter, the application launcher/enabler 130 may direct one or more communication applications, 140a to 140f, associated with the specific activity parameter to request a connection with a representative workstation 130. For example, activity parameter 122b may be associated with an audio (VOIP) 140a and a co-browsing 140e communication application. Activity parameter 122c may be associated with audio 140a and video 140b but not with co-browsing 140e.

Each activity parameter may be downloaded either from the server 200, from the representative workstation 300, or from any other database functionally associated with either the server 200 or the workstation 300. The activity parameter may be correlated to a profile of a user of the client application 100 and/or may be correlated to conditions associated with the representative call or contact center. For example, if the client application 100 has already accessed information on an e-commerce server 200 and conducted a transaction through that server, a profile of the user of the client application may exist on a database associated with the specific server 200. The next time the same client application 100 accesses the specific server 200, the server 200 may upload to the user's computing device one or activity parameters making with low activity thresholds, thus making it easy for the user's system to connect to the representative workstation 300. In another example, if the same user previously connected with the server 200 but did not conduct a transaction and/or had an unproductive interaction with the representative, the server 200 may upload activity parameters with very high activity thresholds, thus making it difficult for that user to be eligible for a connection to the representative workstation 300.

Each activity parameter may either have predefined threshold values, or variable values which may be adapted based on conditions associated with the representative. For example, if the second activity parameter 122b relates to the amount of time a client application 100 must spend accessing specific content (e.g. a web page showing a new model car) before the client application is eligible for a connection, the threshold time value may be fixed to some number of seconds or minutes, or the threshold time value may be a function of the number or available representatives. For example, the threshold time value may increase as the number of available representatives decreases. In the event that there are no available representatives, the threshold time value may be set to infinity, such that a request for a connection with a representative is not possible until a representative becomes available.

Threshold activity values in an activity parameter may be set during the downloading of an activity parameter from either the server 200 or a database associated with the workstation 300. As mentioned above, the specific parameter downloaded and the threshold values therein may be a function of the user's profile and/or conditions associated with the representative. In a further embodiment, activity threshold values within an already downloaded activity parameter may be updated either by the server 200, by representative workstation 300, or by some computing device functionally associated with the server 200 and/or by representative workstation 300.

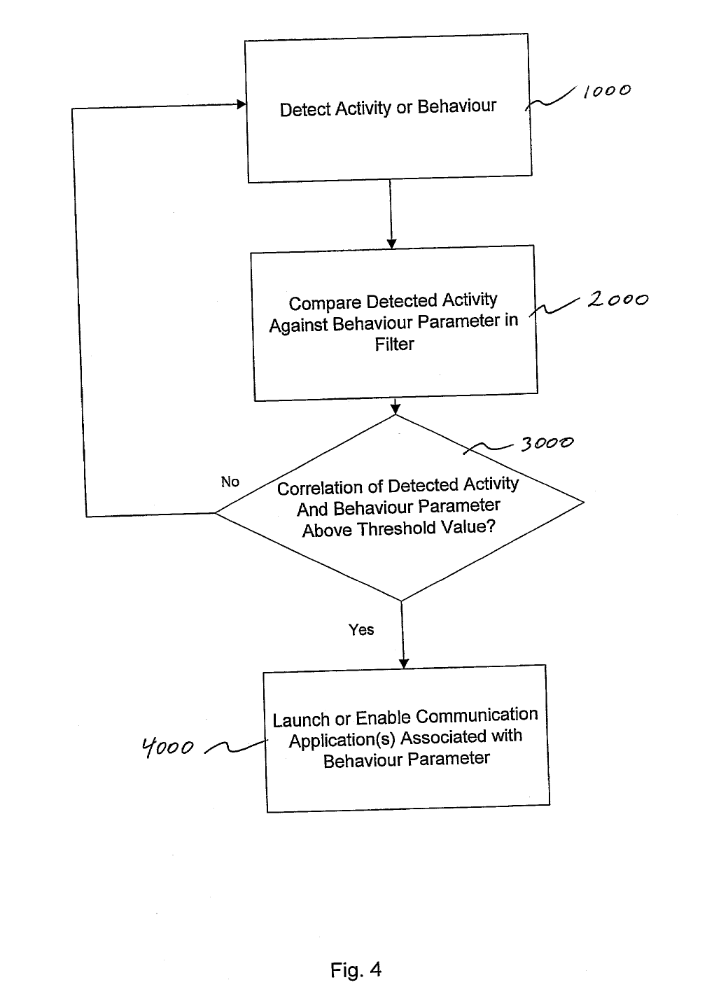

Turning now to FIG. 4, there is shown a flow chart with the steps of a method by which the present invention may be implemented. As part of step 1000, activity or behavior of a user of a computer with a client application 100 is monitored or detected. The detected activity is compared against one or more activity parameters 122 in an activity filter 120. As part of a step 3000 a determination is made whether the detected activity is sufficiently correlated to a given activity parameter in order to launch or enable a communications application associated with the given parameter. In the event that the determination is yes, the associated communication application is either launched or enabled as part of step 4000. In the event that as part of step 3000 a determination is made that the detected activity does not sufficiently correlate to an activity parameter in order to warrant the launching of a communication application, further activity detection takes place.

While certain features of the present invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method of initiating communication between a computing device with a client application accessing data from a server and a representative workstation associated with the server, said method comprising detecting activity on the computing device, determining whether the detected activity sufficiently correlates with an activity parameter, and enabling a communications application if the detected activity sufficiently correlates with the activity parameter.

2. The method according to claim 1, further comprising providing a user of the computing device with the option of initiating communication between the computing device and the representative workstation.

3. The method according to claim 1, further comprising uploading to the computing device at least one activity parameter.

4. The method according to claim 3, wherein the activity parameter is uploaded from a database associated with the server.

5. The method according to claim 4, wherein the activity parameter is uploaded from a database associated with the server is correlated to a profile of a user of the computing device.

6. The method according to claim 3, wherein the activity parameter is uploaded from a database associated with the representative workstation.

7. The method according to claim 6, wherein the activity parameter uploaded from a database associated with the representative workstation is correlated to a condition associated with the representative workstation.

8. The method according to claim 7, wherein the activity parameter uploaded from a database associated with the workstation is correlated to the number of available representatives.

9. A system for initiating communication between a computing device with a client application accessing data from a server and a representative workstation associated with the server, said system comprising:
an activity detector to monitor inputs to the computing device;
a behavior filter to determine whether the detected activity qualifies for communication between said computing device and the representative and to produced a qualifying indicator; and
a communication module to enable at least one communication application in response to a qualifying indicator.

10. The system according to claim 9, wherein said behavior filter is comprised of at least one activity parameter and said behavior filter is adapted to produce a parameter correlation indicator when a correlation between the detected behavior and an activity parameter is above a threshold level.

11. The system according to claim 10, wherein said at least one activity parameter is associated with at least one communication application, and said communication module is adapted to enable a given activity parameter's associated communication application upon receiving an activity correlation indicator for the given activity parameter.

12. The system according to claim 11, wherein the at least one activity parameter is uploaded from a database associated with the server.

13. The system according to claim 12, wherein the activity parameter uploaded from a database associated with the server is correlated to a profile of a user of the computing device.

14. The system according to claim 11, wherein the activity parameter is uploaded from a database associated with the representative workstation.

15. The system according to claim 14, wherein the activity parameter uploaded from a database associated with the representative workstation is correlated to a condition associated with the representative workstation.

16. The system according to claim 15, wherein the activity parameter uploaded from a database associated with the workstation is correlated to the number of available representatives.
